(19) United States
(12) Patent Application Publication
(10) Pub. No.: US 2018/0126303 A1
(43) Pub. Date: May 10, 2018

(54) SYSTEM AND METHOD INCLUDING A STRAINER GASKET

(71) Applicant: Paul R. Bokelmann, Sister Bay, WI (US)

(72) Inventor: Paul R. Bokelmann, Sister Bay, WI (US)

(21) Appl. No.: 15/680,066

(22) Filed: Aug. 17, 2017

Related U.S. Application Data
(60) Provisional application No. 62/376,168, filed on Aug. 17, 2016.

(51) Int. Cl. B01D 29/03

(52) U.S. Cl. CPC B01D 29/03; A01J 11/06; B01D 2201/342; B01D 2201/184

(57) ABSTRACT

A strainer gasket assembly system and method is disclosed. In one example, the assembly includes a strainer barrier defined as a disk having a disk outer diameter, the strainer barrier including a plurality of openings in a predetermined pattern located within an inner area defined by a circle having a circle diameter; and a gasket positioned about an outer edge portion of the disk, the gasket having a gasket inner diameter greater than the circle diameter thereby creating a disk gap area void of any openings. In one example, the disk gap area is an annular shaped area.

### CROSS-REFERENCE TO RELATED APPLICATIONS

This Utility patent application is a non-provisional application of U.S. Ser. No. 62/376,168, filed Aug. 17, 2016, which is incorporated herein by reference.

### BACKGROUND

A straining barrier and process including a straining barrier is disclosed. In one example, the straining barrier is used in an In-Line Strainer or Tube Line conforming to the requirements in the 3-A® Sanitary Standards for In-Line Strainers for Milk and Milk Products, Number 42-01 and 3-A® Sanitary Standards for Sanitary Fittings, Number 63-03 as published by 3-A® Sanitary Standards, Inc. and accepted by the United States Department of Agriculture Dairy Plant Survey Program for use in sanitary in-line strainers and tube lines.

A straining barrier used in an in-line strainer or tube line is mounted into an in-line strainer assembly or a tube line for milk and milk products and cleaning solution applications. The straining barrier prevents the passage of undesired foreign material into the product stream. Straining barriers in a Sanitary In-Line Strainer used in Milk and Milk Product systems need to conform to the 3-A® Sanitary Standards for In-Line Strainers for Milk and Milk Products, Number 42-01 as published by 3-A® Sanitary Standards, Inc. and accepted by the United States Department of Agriculture Dairy Plant Survey Program for use in sanitary in-line strainers or tube lines.

There are at least two types of straining barriers currently available. One type of straining barrier is generally made with stainless steel wire mesh. Wire mesh is disallowed completely under the 3-A® Sanitary Standard 42-01 and not accepted by the USDA in these applications. Another type of straining barrier is made with a perforated metal disk. Typically, a large metal sheet that is completely perforated is cut into circular disks and in some cases, molded into an elastomer border. In some cases, the disk can slip in and out of the elastomer gasket. Further, known straining barriers do not conform to the requirements in 3-A® Sanitary Standard Number 42-01 nor are they accepted by the USDA.

Perforated barriers having entirely perforated disks, as described above, when embedded into the elastomer material produces numerous crevices when a perforation is intersecting the cylindrical inner margin or diameter of the elastomer gasket. The crevice is generally worse when a perforation is only 50-100% covered by elastomer material. These crevices can harbor bacteria. When the perforation is very small, the crevice can be even worse.

For these and other reasons, there is a need for the present invention.

### BRIEF DESCRIPTION OF THE DRAWINGS

FIG. 1 illustrates one example of a strainer gasket suitable for use in an in-line fluid piping system.

FIG. 2 illustrates one example of a strainer barrier.

FIG. 3 illustrates one example of a gasket.

FIG. 4 is a perspective view illustrating another example of a strainer gasket.

FIG. 5 is a side view of the strainer gasket of FIG. 4.

FIG. 6 is a cross-sectional view of the strainer gasket of FIG. 5, taken along A-A.

FIG. 7 is a perspective view illustrating another example of a strainer barrier.

FIG. 8 is a side view of the strainer barrier of FIG. 7.

FIG. 9 is a cross-sectional view of the strainer gasket of FIG. 8, taken along A-A.

FIG. 10 is a system diagram illustrating one example of a fluid filtration system including a strainer gasket assembly suitable for use as an in-line fluid filtration system.

FIG. 11 is a perspective view illustrating one example of a strainer gasket assembly.

FIG. 12 is a diagram illustrating one example of the strainer gasket assembly of FIG. 11.

FIG. 13 is a cross-sectional view of the strainer gasket assembly of FIG. 12, taken along A-A.

FIG. 14 is an enlarged view of detail B illustrated in FIG. 13.

FIG. 15 is a cross-sectional view of the gasket housing of FIG. 12, taken along C-C.

### DETAILED DESCRIPTION

In the following Detailed Description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

One or more examples of a system and method including a strainer gasket suitable for use in a strainer gasket assembly as part of a fluid filtration system are disclosed. In one example, the fluid filtration system is a clean in place system used in the dairy industry. In one example, the system includes a piping system and an inline fluid filtration system with a strainer gasket. The strainer gasket includes a strainer barrier having a gasket positioned about an outer edge of the strainer barrier. The strainer gasket has a dedicated area of strainer openings spaced from an inner edge of the gasket.

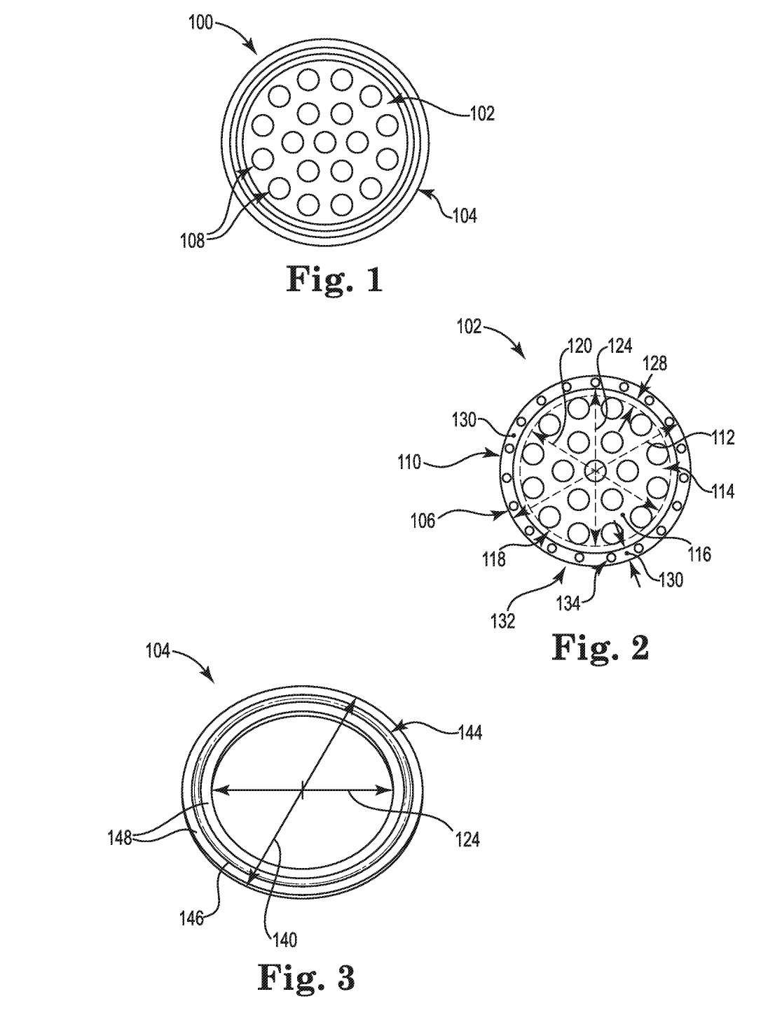

FIG. 1 illustrates at 100 one example of a strainer gasket suitable for use in an in-line fluid piping system. The strainer gasket 100 includes a strainer barrier 102 and a gasket 104. Reference is also made to FIG. 2, illustrating strainer barrier 102, and FIG. 3, illustrating gasket 104. Gasket 104 is positioned about an outer edge portion 106 of strainer barrier 102. Strainer gasket 100 has an area of strainer openings 108 spaced from and inner edge of gasket 104. When positioned in an in-line fluid piping system as part of a fluid filtration system, the strainer gasket 100 provides efficient fluid filtering due to no partial openings, and no portion of the gasket interfering with the openings and filtering process.

In one example, strainer barrier 102 is a disk 110. The disk 110 has an outer diameter 112. The disk 110 includes a plurality of strainer openings 108 in a pattern 114. In one example, the pattern is a predetermined pattern. The openings 108 are located within an inner area 116 defined by a boundary or circle 118 having a circle diameter 120. In other embodiments, the boundary that defines inner area 116 does not take the shape of a circle. Further, disk 110 includes outer edge portion 106.

When assembled, the gasket 104 is positioned about the outer edge portion 106 of disk 110. Gasket 104 includes a gasket inner diameter 124. The Gasket inner diameter 124 is greater than the circle diameter 120. The difference between gasket inner diameter 124 and circle diameter 120 creates a disk gap area 128 that is free or void of any openings. In the example illustrated, the disk gap area is an annular shaped gap.

In one example, disk 110 is a circular disk. In other examples, the strainer barrier has a shape other than a circle. In one example, the strainer barrier is made of metal. One metal suitable for use in an in-line fluid piping system is stainless steel. In one example the openings 108 are circular openings. In other examples, the openings have other shapes such as oblong, rectangular, or square. Further, in other embodiments the openings are not all the same shape. In one example, the openings are perforated openings.

In one example, the disk includes a strainer gasket area 130. The strainer gasket area 130 is defined by the gasket inner diameter 124 location on the disk 110 and the disk outer diameter 112. A mechanism 132 is located within the strainer gasket area 130 that is configured to aid in securing the gasket 104 to the strainer barrier 102. In one example, the mechanism 132 is a plurality of openings or holes 134 spaced apart in the strainer gasket area 130. When gasket 104 is positioned about strainer barrier 102 to form strainer gasket 100, the gasket material extends through openings or holes 134. In one aspect, the gasket is made of an elastomer material.

Gasket 104 is further defined by an outer diameter 140. In one example, the outer diameter 140 is greater than the disk outer diameter 112. It is noted that gasket 104 further includes a gasket sealing mechanism 144. The gasket sealing mechanism 144 operates to aid in coupling and sealing the strainer gasket along a fluid piping system. In one example, the gasket sealing mechanism aids in coupling and sealing the strainer gasket to a gasket assembly housing. In the example shown, the gasket sealing system is in the form of a circular ridge 146 extending from the gasket surface 148. In other examples, the gasket sealing system may take on other shapes and forms such as a valley or a plurality of notches or posts.

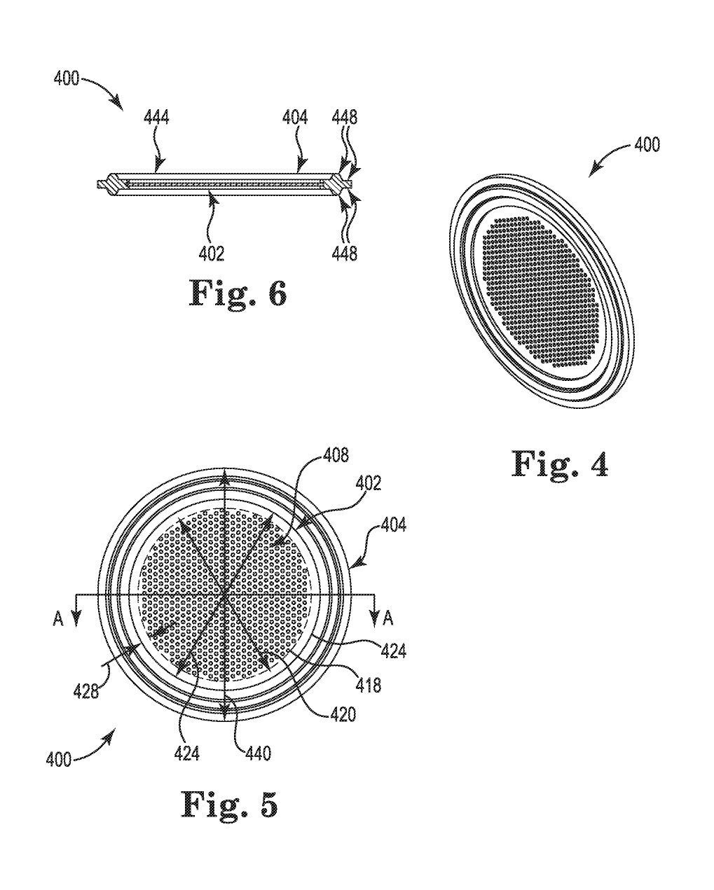

FIG. 4 is a perspective view illustrating another example of a strainer gasket, indicated at 400. FIG. 5 is a side view of the strainer gasket of FIG. 4. FIG. 6 is a cross-sectional view of the strainer gasket of FIG. 5, taken along A-A. Strainer gasket 400 is similar to the strainer gasket 100 previously described herein, with similar elements having a similar element numbers. As such, all element numbers are not described again in detail. Strainer gasket 400 includes strainer barrier 402 and gasket 404. FIG. 6 is a cross-sectional view of the strainer gasket 400 of FIG. 5, taken along A-A.

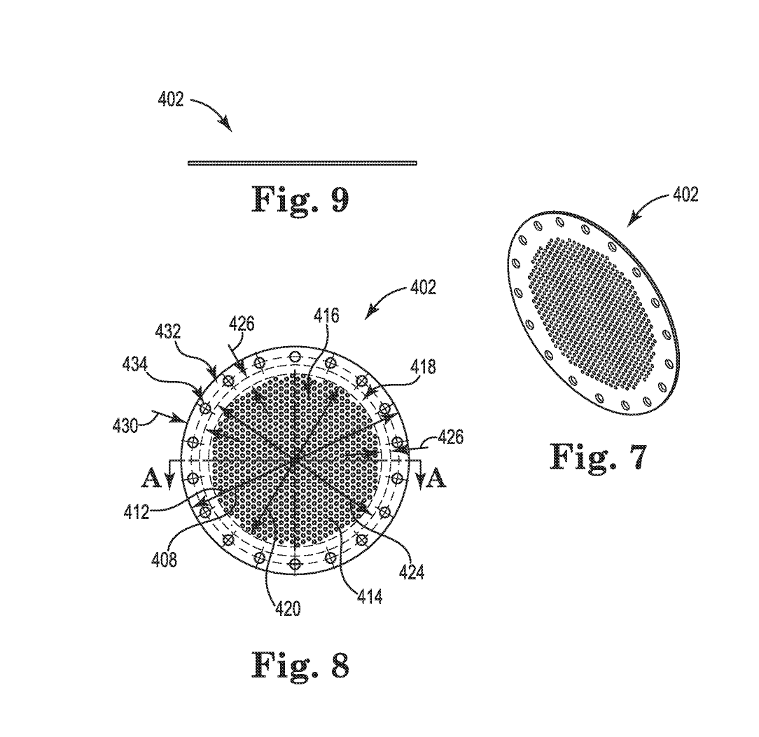

Strainer gasket 400 illustrates another example of a pattern of strainer openings, indicated as openings 408. In this example, the openings 408 are a large number of perforations all located within circle 418. Reference is also made to the strainer barrier 402 illustrated in detail in FIG. 7, FIG. 8, and FIG. 9. Again, all perforations are located within circle 418. The circle 418 includes a circle diameter 420 which is less than the gasket inner diameter 424 defining disk gap are 428. The gasket inner diameter 424 is defined by the inner boundary of the gasket 404. The location of gasket inner diameter 424 is also shown on strainer barrier 402. There are no openings or perforations, including partial perforations, located in disk gap area 428. In other strainer gaskets having other strainer barrier and gasket shapes, the gap remains to isolate the strainer barrier openings from the gasket. In these other examples, the gap is defined by the space between an inside edge of the gasket and an outer boundary of the openings in the strainer barrier. In one example illustrated, the gap 428 between the gasket inner diameter 424 and circle diameter 420 is 0.15 inches where the gasket inner diameter is 1.90 inches and the circle diameter is 1.75 inches.

It is recognized that the strainer barrier perforations or opening sizes may vary, within the scope of the present examples. For example, in one or more embodiments, the perforations are circular shaped and range in diameter from 0.033 inches to 0.5 inches. In other examples, it may be advantageous to have the minimum diameter allowed by 3-A sanitary standards. The strainer barrier inner diameter containing the openings can also vary in size based on the piping system. In one example, the strainer barrier inner diameter ranges from 0.5 inches to 6 inches. In other examples, it may be advantageous to have other inner diameters. The gasket may be made of any suitable flexible gasket material. Suitable materials may include elastomers, silicones, or polymers.

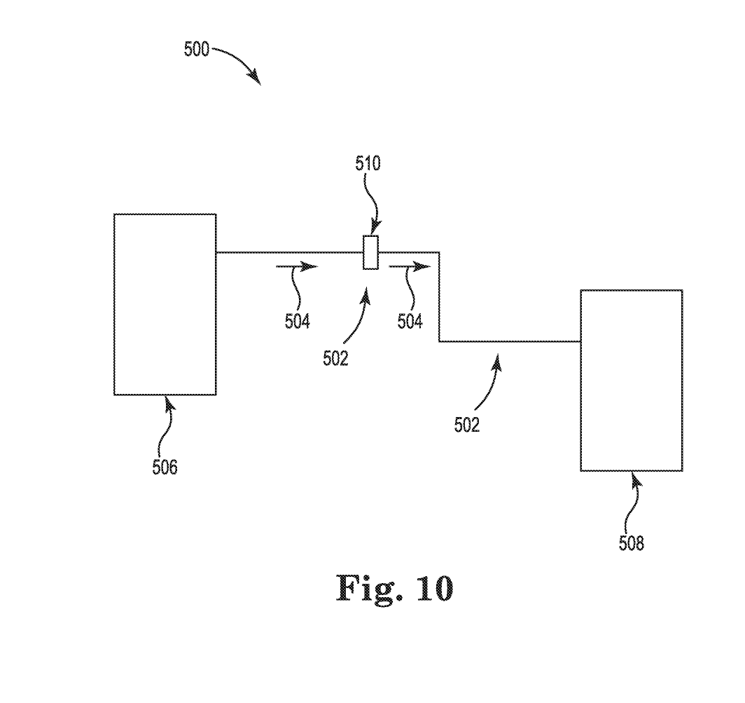

FIG. 10 is a diagram illustrating at 500 one example of a fluid filtration system. In one embodiment the fluid filtration system includes a piping system 502 for transferring fluid 504 from a first location 506 to a second location 508. A strainer gasket assembly 510 is positioned along the piping system 502 to filter the fluid 504 transferred from first location 506 to second location 508. In one embodiment, the fluid filtration system is suitable for use in a dairy plant.

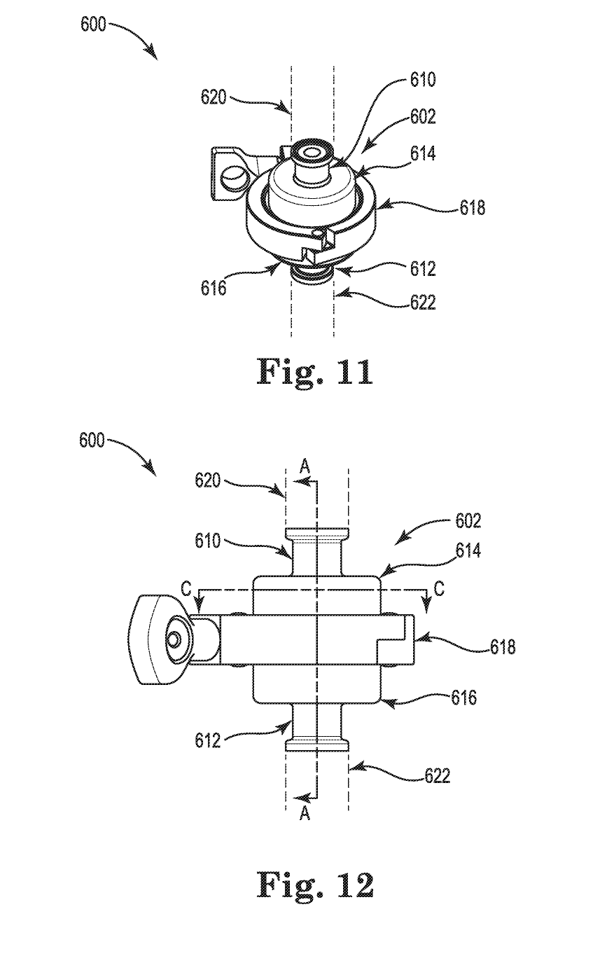

FIG. 11 is a perspective view illustrating at 600 one example of a strainer gasket assembly. Strainer gasket assembly 600 is one example of a strainer gasket assembly is suitable for use as strainer gasket assembly 510 in fluid filtration system 500. The strainer gasket assembly 600 includes a gasket housing having a strainer gasket secured within the gasket housing. FIG. 12 is a diagram illustrating at 602 one example of the gasket housing of FIG. 11. The gasket housing 602 includes a gasket housing inlet pipe 610, a gasket housing outlet pipe 612, a first housing 614 and a second housing 616. A clamp system 618 secures the first housing 612 to the second housing 614. Additionally, clamp system 618 retains a strainer gasket within the strainer gasket assembly. Gasket housing inlet pipe 610 couples the gasket assembly 600 to a fluid filtration system inlet pipe 620, and the gasket housing outlet pipe 612 couples the gasket assembly 600 to a fluid filtration system outlet pipe 622 (illustrated in dashed lines).

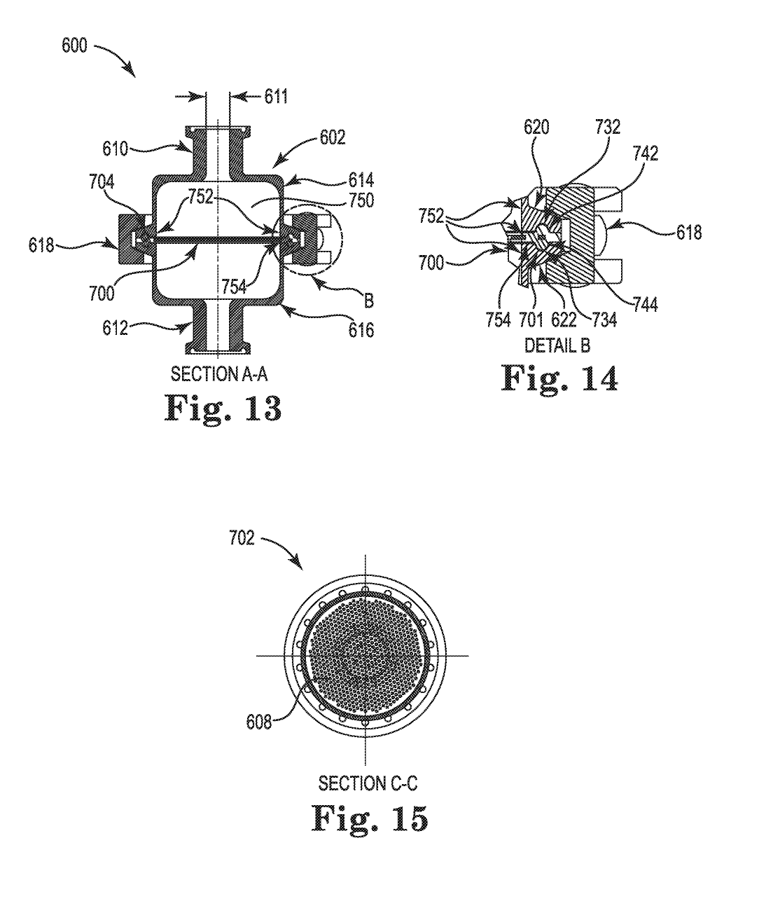

FIG. 13 is a cross-sectional view of the strainer gasket assembly 600 of FIG. 12, taken along A-A. A strainer gasket 700 is securely retained between first housing 614 and second housing 616. Strainer gasket 700 is similar to strainer gasket 100 and 400 previously described herein, with like element numbers indicating like parts. In reference also to FIG. 14, an enlarged view of detail B illustrated in FIG. 13, first housing 614 includes a retention flange 620 and second housing 616 includes a retention flange 622. The strainer gasket 700 is retained between retention flange 620 and retention flange 622. In one example, strainer gasket 700 includes gasket 704 having a ridge 732 and ridge 734. First housing 614 and second housing 616 include corresponding notches 742 and 744. Tightening clamp system 618 operates to secure the strainer gasket 700 within strainer gasket assembly 600 including tightly seating ridge 732 in notch 742 and tightly seating ridge 734 in notch 744.

First housing 614 is secured to second housing 616 form a filtration chamber 750. The strainer gasket 700 is secured within chamber 750. In one example, the strainer gasket assembly 600 operates more efficiently when an inner wall 752 of the chamber 750 is flush with the gasket inner diameter 754. Accordingly, the gasket 704 of strainer gasket 700 does not extend into the chamber 750, avoiding interference with the fluid filtration system, and also makes it compliant with 3-A sanitary standards.

FIG. 15 is a cross-sectional view of the strainer gasket assembly of FIG. 12, taken along C-C. In one example, the strainer gasket is sized as follows. The gasket housing inlet pipe 610 has an inner diameter 611 defining a gasket housing inlet pipe cross-sectional area. In this example, the sum of the area of the openings 608 is equal or greater than the cross-sectional area of the gasket housing inlet pipe. This results in little or no back pressure in the piping system caused by the filtration system.

One or more examples of a system and method including a strainer gasket suitable for use as part of a fluid filtration system are disclosed. In one example, the fluid filtration system is a clean-in-place (CIP) system used in the dairy industry. In one example, the system includes a piping system and an inline fluid filtration system with a strainer gasket. The strainer gasket includes a strainer barrier having a gasket positioned about an outer edge of the strainer barrier. The strainer gasket only has an area of strainer openings spaced from an inner edge of the gasket.

### Dairy System Process Example

In one or more examples, the present strainer barrier system is in compliance with the 3-A® Sanitary Standards for In-Line Strainers for Milk and Milk Products, Number 42-01 and 3-A Sanitary Standards for Sanitary Fittings, Number 63-03 as published by 3-A® Sanitary Standards, Inc. and accepted by the United States Department of Agriculture Dairy Plant Survey Program for use in sanitary in-line strainers and tube lines. These standards are incorporated herein by reference. The strainer barrier perforations in the metal disk are completely within a circle concentric with and smaller in diameter than the cylindrical inner margin of the gasket profile yielding an annular space between the two. This annular space is not perforated and will allow a crevice-free joint between the two parts.

In one example, the system includes a barrier incorporated within an industry standard elastomer gasket profile intended to be clamped between two mating flanges in a tube line or an in-line strainer. Milk or milk products or cleaning solutions pass through the strainer barrier while undesired foreign material is separated from the flow with a plurality of perforations of various sizes. Not only does the invention separate undesired foreign material, it also seals the joint in which it is assembled in accordance with established industry standards.

Sizing is based on the tube line outside diameter. This invention can be used in tube lines with an outside diameter of, but not limited to, ½″, ¾″, 1″, 1½″, 2″, 2½″, 3″ and 4″ with Tri-Clamp®-style flange-type fittings or other type ferrules.

One component is the elastomer gasket portion. In the type of joint used in a milk or milk product application the gasket portion shall conform dimensionally with other Tri-Clamp®-style gaskets and shall comply with 3-A® Sanitary Standards for Sanitary Fittings, Number 63-03 as published by 3-A® Sanitary Standards, Inc. In this invention example, the gasket shape and profile conforms dimensionally with other Tri-Clamp®-style gaskets and 3-A® Standard 63-03. The elastomer portion can be, but not limited to, NBR (acrylonitrile-butadiene rubber, nitrile), EPDM (ethylene propylene rubber), FKM (fluorocarbon rubber, Viton®), Silicone and those elastomers with fillers and additives such as PTFE, stainless steel or metal detectable material. All elastomers shall comply with applicable 3-A® Sanitary Standards.

The strainer barrier portion consists of a circular metal disk with a plurality of perforations in a specific pattern that are completely within a specific sized circle that is concentric to the outside diameter of the disk. The circle diameter is less than that of the inside diameter of the aforementioned elastomer gasket portion so there can be no chance of elastomer migrating into any particular perforation during the molding process which would create crevices. In addition, there are a plurality of specific sized holes in a radial pattern between the outside diameter of the metal disk and the cylindrical inside diameter inside diameter of the gasket. In the molding process, the elastomer will fill in these holes from both sides yielding a much more secure adhesion between the two parts. The metal portion can be, but not limited to, stainless steel grades 304, 304L, 316 and 316L.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A strainer gasket assembly comprising:
a strainer barrier defined as a disk having a disk outer diameter, the strainer barrier including a plurality of openings in a predetermined pattern located within an inner area defined by a circle having a circle diameter; and
a gasket positioned about an outer edge portion of the disk, the gasket having a gasket inner diameter greater than the circle diameter thereby creating a disk gap area void of any openings.

2. The assembly of claim 1, where the disk is a circular disk.

3. The assembly of claim 1, where the disk is made of metal.

4. The assembly of claim 1, where the metal is stainless steel.

5. The assembly of claim 1, where the gasket is made of an elastomer material.

6. The assembly of claim 1, where the openings are circular openings.

7. The assembly of claim 1, where the openings have one of an oblong, rectangular or square shape.

8. The assembly of claim 1, the disk having a strainer gasket area defined by the gasket inner diameter and the disk outer diameter, the strainer gasket area including a mechanism configured to aid in securing the gasket to the strainer barrier.

9. The assembly of claim 8, where the mechanism includes a plurality of holes spaced apart in the strainer gasket area.

10. The assembly of claim 1, where the gasket has a gasket outer diameter greater than the disk outer diameter.

11. The assembly of claim 1, the gasket including a gasket sealing mechanism that aids in sealing and coupling the assembly along a piping system.

12. The assembly of claim 11, where the gasket sealing mechanism includes a ridge.

13. A fluid filtration system for use in the dairy industry comprising:
an inline strainer gasket comprising a strainer barrier defined as a disk having a disk outer diameter, the strainer barrier including a plurality of openings in a predetermined pattern located within an inner area defined by a circle having a circle diameter, and a gasket positioned about an outer edge portion of the disk, the gasket having a gasket inner diameter greater than the circle diameter thereby creating a disk gap area void of any openings; and
a gasket housing configured to retain the strainer gasket, the gasket housing being positionable within a fluid piping system.

14. The system of claim 13, the gasket housing including an inlet pipe and an outlet pipe, where the sum of the areas of the plurality of openings is equal to or greater than an inlet pipe flow area defined by an inside diameter of the inlet pipe.

15. The system of claim 13, the gasket housing having a first housing and a second housing, where the inline strainer gasket is securely retained between the first housing and the second housing within a filtration chamber.

16. The system of claim 14, where the gasket inner diameter is flush with an inner wall of the filtration chamber.

17. The system of claim 14, further comprising a housing clamp that securely clamps the first housing to the second housing.

18. A system comprising:
a piping system for transferring fluid from a first location to a second location; and
an inline strainer gasket comprising a strainer barrier and a gasket positioned about an outer edge of the strainer barrier, the strainer barrier only having strainer openings spaced from an inner edge of the gasket; and
a gasket housing that retains the strainer gasket, where the gasket housing is coupled to the piping system, positioning the inline strainer gasket to filter the fluid transferred from the first location to the second location.

19. The system of claim 17, the gasket including a sealing mechanism that aids in retaining the inline strainer gasket within the gasket housing.

20. The system of claim 18, the strainer barrier including coupling openings adjacent the outer edge that aid in coupling the gasket to the strainer barrier.
